(19) United States
(12) Patent Application Publication
(10) Pub. No.: US 2026/0188094 A1
(43) Pub. Date: Jul. 2, 2026

(54) PROVIDING HEALTH REMINDERS FOR OCCUPANTS OF A VEHICLE

(71) Applicant: Volvo Car Corporation, Göteborg (SE)

(72) Inventors: Giovanni Spiritoso, Göteborg (SE); Boyd Stowe, Ridgeville, SC (US); Jessica Areizaga, Ridgeville, SC (US); Charles Leonardi, Ridgeville, SC (US)

(21) Appl. No.: 19/006,375

(22) Filed: Dec. 31, 2024

(51) Int. Cl. G08B 21/02; G08G 1/16

(52) U.S. Cl. CPC G08B 21/02; G08G 1/16

(57) ABSTRACT

A system for providing health reminders for occupants of a vehicle. The system capturing data associated with a driver of the vehicle using the plurality of perception sensors. The system further detects a health trigger event based on the data that is captured. The system further identifies one or more driver attributes associated with the health trigger event. The system further estimates one or more severity levels of the health trigger event based on the one or more driver attributes that are identified. The system further transmits one or more health alerts to one or more target recipients based on the one or more severity levels meeting a predetermined severity threshold.

### INTRODUCTION

The present disclosure relates generally to the automotive field. When driving, especially long distances, a driver may neglect to stop driving to stretch or walk, or to drink adequately, or to take needed breaks for a pet. A driver may set alarms on a smartphone to provide reminders to take breaks. The driver would then need to comply with the reminders.

The present introduction is provided as background context only and is not intended to be limiting in any manner. It will be readily apparent to those of ordinary skill in the art that the concepts and principles of the present disclosure may be implemented in other applications and contexts equally.

### SUMMARY

The present disclosure relates to a system for providing health reminders for occupants of a vehicle. In one illustrative embodiment, the present disclosure provides a system including a plurality of perception sensors, one or more processors, and logic encoded in one or more non-transitory computer-readable storage media for execution by the one or more processors. The logic when executed is operable to cause the one or more processors to perform operations including: capturing data associated with a driver of the vehicle using the plurality of perception sensors; detecting a health trigger event based on the data that is captured; identifying one or more driver attributes associated with the health trigger event; estimating one or more severity levels of the health trigger event based on the one or more driver attributes that are identified; and transmitting one or more health alerts to one or more target recipients based on the one or more severity levels meeting a predetermined severity threshold. Optionally, in some embodiments, the one or more driver attributes comprise one or more of abnormal head movement, abnormal eye movement, and abnormal hand movement. In some embodiments, at least one health alert of the one or more health alerts is transmitted to the driver of the vehicle, and wherein the at least one health alert provides one or more recommended actions for the driver of the vehicle. In some embodiments, the logic when executed is further operable to cause the one or more processors to perform operations comprising: learning one or more behavior patterns of the driver of the vehicle based on driver compliance with one or more previously recommended actions; and performing one or more safety actions of the vehicle to avoid an accident. In some embodiments, at least one service alert of the one or more service alerts is transmitted to at least one third party entity, and wherein the least one third party entity alerts other drivers of any hazardous conditions associated with driver of the vehicle. In some embodiments, the logic when executed is further operable to cause the one or more processors to perform operations comprising: identifying one or more vehicle performance attributes associated with the health trigger event; and estimating one or more severity levels of the health trigger event based on the one or more vehicle performance attributes that are identified. In some embodiments, the logic when executed is further operable to cause the one or more processors to perform operations comprising identifying one or more vehicle performance attributes associated with the health trigger event, and wherein the one or more vehicle performance attributes comprise abnormal steering.

In another illustrative embodiment, the present disclosure provides a non-transitory computer-readable storage medium with program instructions stored thereon. The program instructions when executed by one or more processors are operable to cause the one or more processors to perform operations including: capturing data associated with a driver of the vehicle using the plurality of perception sensors; detecting a health trigger event based on the data that is captured; identifying one or more driver attributes associated with the health trigger event; estimating one or more severity levels of the health trigger event based on the one or more driver attributes that are identified; and transmitting one or more health alerts to one or more target recipients based on the one or more severity levels meeting a predetermined severity threshold. Optionally, in some embodiments, the one or more driver attributes comprise one or more of abnormal head movement, abnormal eye movement, and abnormal hand movement. In some embodiments, at least one health alert of the one or more health alerts is transmitted to the driver of the vehicle, and wherein the at least one health alert provides one or more recommended actions for the driver of the vehicle. In some embodiments, the instructions when executed are further operable to cause the one or more processors to perform operations comprising: learning one or more behavior patterns of the driver of the vehicle based on driver compliance with one or more previously recommended actions; and performing one or more safety actions of the vehicle to avoid an accident. In some embodiments, at least one service alert of the one or more service alerts is transmitted to at least one third party entity, and wherein the least one third party entity alerts other drivers of any hazardous conditions associated with driver of the vehicle. In some embodiments, the instructions when executed are further operable to cause the one or more processors to perform operations comprising: identifying one or more vehicle performance attributes associated with the health trigger event; and estimating one or more severity levels of the health trigger event based on the one or more vehicle performance attributes that are identified. In some embodiments, the instructions when executed are further operable to cause the one or more processors to perform operations comprising identifying one or more vehicle performance attributes associated with the health trigger event, and wherein the one or more vehicle performance attributes comprise abnormal steering.

In a further illustrative embodiment, the present disclosure provides a computer-implemented method for providing health reminders for occupants of a vehicle, the method including: capturing data associated with a driver of the vehicle using the plurality of perception sensors; detecting a health trigger event based on the data that is captured; identifying one or more driver attributes associated with the health trigger event; estimating one or more severity levels of the health trigger event based on the one or more driver attributes that are identified; and transmitting one or more health alerts to one or more target recipients based on the one or more severity levels meeting a predetermined severity threshold. Optionally, in some embodiments, the one or more driver attributes comprise one or more of abnormal head movement, abnormal eye movement, and abnormal hand movement. In some embodiments, at least one health alert of the one or more health alerts is transmitted to the driver of the vehicle, and wherein the at least one health alert provides one or more recommended actions for the driver of the vehicle. In some embodiments, the method further includes: learning one or more behavior patterns of the driver of the vehicle based on driver compliance with one or more previously recommended actions; and performing one or more safety actions of the vehicle to avoid an accident. In some embodiments, at least one service alert of the one or more service alerts is transmitted to at least one third party entity, and wherein the least one third party entity alerts other drivers of any hazardous conditions associated with driver of the vehicle. In some embodiments, the method further includes identifying one or more vehicle performance attributes associated with the health trigger event; and estimating one or more severity levels of the health trigger event based on the one or more vehicle performance attributes that are identified.

### BRIEF DESCRIPTION OF THE DRAWINGS

The present disclosure is illustrated and described with reference to the various drawings, in which like reference numbers are used to denote like system components and/or method steps, as appropriate.

FIG. 1 is a block diagram of an example environment for providing health reminders for occupants of a vehicle.

FIG. 2 is a flow chart for providing health reminders for occupants of a vehicle.

FIG. 3 is a side-view block diagram of an example environment of the interior of a vehicle.

FIG. 4 is a block diagram of an environment, showing a view toward the front interior of a vehicle.

FIG. 5 is a block diagram of an example high-level architecture for providing health reminders for occupants of a vehicle.

FIG. 6 is a block diagram of an example network environment of the present disclosure.

FIG. 7 is a block diagram of an example computing system of the present disclosure.

### DETAILED DESCRIPTION

A system for providing health reminders for occupants of a vehicle. As described in more detail herein, a system utilizes cameras and other sensors, and AI to monitor the health of a driver and other vehicle occupants, including pets. The system suggests stops and breaks for water, restroom, walking, hiking, etc. These suggestions may be based on real-time observation of the driver, knowledge about the driver, learned behavior of the driver, knowledge of the health conditions of the driver and other occupants in the vehicle, etc. For example, the system may also recommend safe and desirable stops via a navigation system. Furthermore, in an autonomous vehicle, the system may cause the vehicle to function as follower vehicle on a suggested walking or hiking area, or provide the driver with appropriate drop off and pick up locations.

In various embodiments, a system captures data associated with the driver of the vehicle using various perception sensors. The system further detects a health trigger event based on the data that is captured, and then identifies one or more driver attributes associated with the health trigger event. The system further estimates one or more severity levels of the health trigger event based on the one or more driver attributes that are identified. The system then transmits health alerts to one or more target recipients based on the one or more severity levels based on the one or more severity levels meeting a predetermined severity threshold. Further example embodiments are described in more detail herein.

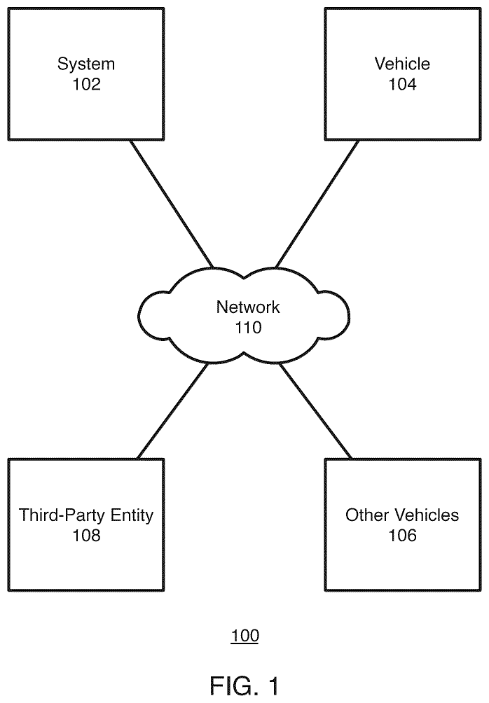

FIG. 1 is a block diagram of an example environment 100 for providing health reminders for occupants of a vehicle. Shown are blocks that represent a system 102, a vehicle 104, other vehicles 106, a third-party entity 108, and a network 110. As described in more detail herein, the system 102 alerts the driver and/or other occupants of the vehicle 104 with health reminders. For example, the system may remind the driver to take a break from driving after a predetermined time period of driving (e.g., after 2 hours, after 4 hours, etc.) or predetermined length of driving (e.g., after 100 miles, after 200 miles, etc.). In another example, after a predetermined time period or length of driving, the system may suggest to another occupant in the vehicle to keep the driver company to ensure that the driver stays awake while driving. Further example embodiments directed to alerts are described in more detail below.

The system may also alert other vehicles 106 if a serious problem arises with respect to the driver of the vehicle 104. For example, the driver of the vehicle 104 may have fallen asleep or fallen ill or may be intoxicated. In such scenarios, the system may warn other drivers to stay clear of the vehicle 104. Further example embodiments directed to alerts to other drivers are described in more detail below.

The system may also alert a third-party entity 108 of the problem. The third-party entity 108 may be a traffic control center, for example. If the severity of the problem is severe enough to cause the vehicle 104 to be a potential hazard to other vehicles driving in proximity to the vehicle 104, the third-party entity 108 may alert the relevant drivers in proximity to the vehicle 104 in order to prevent collisions. For example, if the driver of the vehicle 104 starts getting drowsy after long hours of driving, the system may alert the third-party entity 108, which may in turn warn other drivers to stay clear of the vehicle 104. Further example embodiments directed to third-party entities are described in more detail below.

In various embodiments, the vehicle 104 includes a variety of perception sensors coupled to a vehicle. Perception sensors on the interior of vehicle 104 may enable the system 102 and the vehicle 104 to monitor various aspects of the driver of the vehicle 104. Example perception sensors on the interior of the vehicle 104 may include video cameras, eye tracking cameras, motion sensors, etc. These perception sensors may detect that the driver's head begins nodding up and down, or if the eyes of the driver begin to close, etc.

Perception sensors positioned around the vehicle may enable the system 102 and the vehicle 104 to monitor various performance aspects of the vehicle 104. These perception sensors may include standard engine and vehicle sensors, including oxygen sensors, vibration sensors, special sensors for particular vehicle components (e.g., tire pressure sensors, etc.), transmission sensos, etc. Perception sensors may detect if the vehicle 104 begins swerving, the vehicle slows down to an unsafe speed on a highway or freeway, etc.

The system 102 may communicate with the vehicle 104, the other vehicles 106, and the third-party entity 108 directly or via a network 110. The network 108 may be any suitable communication network such as a Bluetooth network, a Wi-Fi network, the Internet, etc.

For ease of illustration, FIG. 1 shows one block for each of the system 102, the vehicle 104, the other vehicles 106, the third-party entity 108, and the network 110. Blocks 102, 104, 106, 108, and 110 may represent multiple systems, vehicles, third-party entities, or networks. In other embodiments, environment 100 may not have all of the components shown and/or may have other elements including other types of elements instead of, or in addition to, those shown herein.

While system 102 performs embodiments described herein, in other embodiments, any suitable component or combination of components associated with system 102 or any suitable processor or processors associated with system 102 may facilitate performing the embodiments described herein.

While the system 102 is shown in the example embodiment of FIG. 1 as being separate from the vehicle 104, in various embodiments, the system 102 may also be on board or integrated with the vehicle 104.

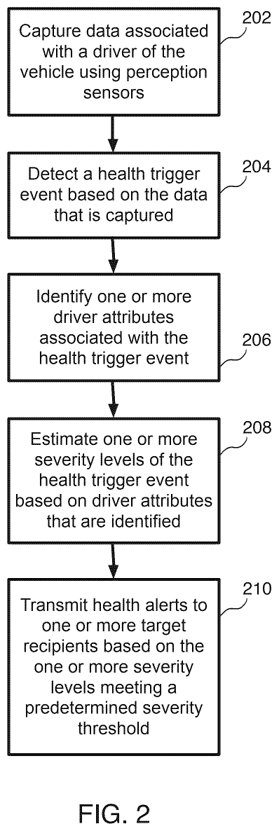

FIG. 2 is a flow chart for providing health reminders for occupants of a vehicle. Referring to both FIGS. 1 and 2, a method is initiated at block 202, where a system such as system 102 captures data associated with the driver of the vehicle 104 using perception sensors. As indicated herein, the perception sensor may include video cameras, motion sensors, eye tracking cameras, etc. These perception sensors are located on the interior of the vehicle 104 a positioned at various locations to monitor movements and behavior of the driver to ensure that the driver is driving the vehicle 104 in a safe manner.

At block 204, the system 102 detects a health trigger event based on the data that is captured. Health trigger events may include, for example, a predetermined time period of driving non-stop (e.g., 2 hours, 3 hours, etc.), a predetermined number of miles driving non-stop (e.g., 100 miles, 200 miles, etc. ,). Other examples of health trigger events may include changes to the user's body position. Such a change may include, for example, the driver's eyes starting to close or closing.

At block 206, the system 102 identifies one or more driver attributes associated with the health trigger event. In various embodiments, the driver attributes may include abnormal head movement, abnormal eye movement, and abnormal hand movement. For example, the system may identify images or videos of the driver nodding or closing the eyes. In various embodiments, the system may generate and store profile for each driver of the vehicle. The system may then learn safe and unsafe behavior patterns of each driver to ensure safter driving practices.

At block 208, the system 102 estimates one or more severity levels of the health trigger event based on the one or more driver attributes that are identified. For example, the system may track that the driver is slightly nodding or that the eyes of the driver are slightly closing. Or, the system may track the that the drivers head is staying down longer or that the eyes of the driver are almost closed. In some embodiments, the system may have collected data showing that a particular driver tends to get sleepy after certain time in the evening. The system may calibrate severity levels for different scenarios (e.g., late nigh driving, long distance driving, etc.) and for different drivers.

At block 210, the system 102 transmits health alerts to one or more target recipients based on the one or more severity levels meeting a predetermined severity threshold. For example, if the system determines that the vehicle has been driving a relatively long time (e.g., 2 hours) and the eyes of the driver have started to closes a little bit, the system may transmit a health alert reminding the driver to take a break from driving. If the system determines that the vehicle has been driving relatively long time (e.g., 2 hours) and the eyes of the driver have closed are not opening, the system may transmit a loud health alert and flashing lights to wake up the driver. In an autonomous vehicle scenario, the system may take control of the vehicle and pull over to a safe spot.

In various embodiments, the system transmits at least one health alert to the driver of the vehicle, where the health alert provides one or more recommended actions for the driver of the vehicle. For example, the system may also recommend safe and desirable stops via a navigation system. Furthermore, in an autonomous vehicle, the system may cause the vehicle to function as follower vehicle on a suggested walking or hiking area, or provide the driver with appropriate drop off and pick up locations.

In various embodiments, the system learns one or more behavior patterns of the driver of the vehicle based on driver compliance with one or more previously recommended actions. For example, if the system has reminded the driver to take a break after a certain amount of driving, and the driver had ignored the reminder, but then started swerving, the system would log the driver has ignored recommendations, which resulted in increased risk of an accident. In some embodiments, the system may issue a more prominent warning. For example, the alert may include flashing lights, red font, etc. The alert may also be accompanied by auditory sound.

In various embodiments, the system performs one or more safety actions of the vehicle to avoid an accident. For example, in some embodiment, if capable, the system may take control of the vehicle and pull over to safe location.

In various embodiments, the system may monitor other occupants in the vehicle. For example, the system may detect that a pet is in the vehicle. The system may use AI to monitor the movement and breathing patterns of the pet to ensure that the pet is behaving normally. If the pet is not moving but is breathing heavily, the system may also check the temperature of the inside of the vehicle. The system may determine that the pet may be overheating. The system may provide a warning to the driver of the vehicle.

In various embodiments, the system transmits at least one alert to a third party entity. In an example scenario, if the system determines that the driver's behavior is becoming dangerous, such as the driver starting to fall asleep or starting to pass, the system may alert a third-party entity, which may be a traffic control or traffic infrastructure system. In such scenarios, the third-party entity receives the service alert and alerts other drivers of any hazardous conditions associated with driver of the vehicle. The third-party entity may also control traffic signals if possible to keep other cars safe.

In various embodiments, the system identifies one or more vehicle performance attributes associated with the health trigger event. For example, the system may determine that the vehicle is continuously slowing down and not turning while on a freeway. The system then estimates one or more severity levels of the health trigger event based on the one or more vehicle performance attributes that are identified. For example, the system may determine that the driver's eyes are closed, and/or the driver's head is facing forward and downward, as if sleeping.

In another example scenario, the system identifies one or more vehicle performance attributes associated with the health trigger event, where the vehicle performance attributes include abnormal steering. This may be a scenario, for instance, where the driver is intoxicated or distracted. Regardless of the cause, the system identifies the abnormal steering and can then issue and appropriate alerts to the driver and/or a third-party entity.

In various embodiments, the system stores or has access to health information associated with the driver and other occupant in the vehicle. If there is an accident, the system may provide important health information to a third-party entity such as a first responder.

Although the steps, operations, or computations may be presented in a specific order, the order may be changed in particular embodiments. Other orderings of the steps are possible, depending on the particular implementation. In some particular embodiments, multiple steps shown as sequential in this specification may be performed at the same time. Also, some embodiments may not have all of the steps shown and/or may have other steps instead of, or in addition to, those shown herein.

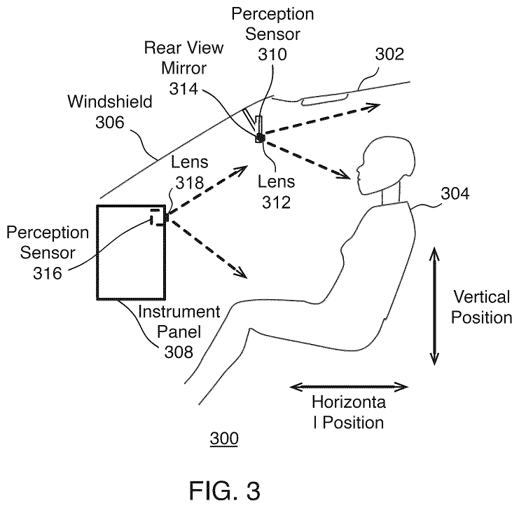

FIG. 3 is a side-view block diagram of an example environment 300 of the interior of a vehicle 302. The vehicle 302 may represent the vehicle 104 of FIG. 1. Shown is a driver 304 in a seated position facing toward the windshield 306 and the instrument panel 308. Also shown are a perception sensor 310 with a lens 312 coupled to a rear view mirror 314, and a perception sensor 316 with a lens 318 coupled to the instrument panel 308. The system utilizes these perceptions sensors in the interior of the vehicle 302 to capture images of the driver 304. The perception sensor 310 and the lens 312 are positioned to view the eyes of the driver 304. As such, the perception sensor 310 captures images of the eyes of the driver. By capturing the images of the eyes of the driver, the system may determine the position or height of the eyes of the driver as well as the gaze of the eyes of the driver. The system may determine if the eyes of the driver are slowly closing indicating drowsiness. Both the perception sensor 310 and the perception sensor 316 are positioned to view the head of the driver 304. As such, these perception sensors may detect up and down nods of the driver 304 indicating drowsiness. As described in more detail herein, the system may utilize data from such signal to determine whether a hazardous situation of driver drowsiness may be arising.

In the embodiment shown, the perception sensor 310 is integrated into the rear view mirror 314. In some embodiments, the perception sensor 310 may be mounted on the rear view mirror 314. Also shown is the perception sensor 316 is integrated into the instrument panel 308. In some embodiments, the perception sensor 316 may be mounted on the instrument panel 308. The perception sensor 316 is positioned to view the body of the driver 304. As such, the perception sensor 316 captures images of the body of the driver 304. By capturing the images of the body of the driver 304, the system may determine when changes in the position of body of the driver 304 indicate drowsiness, discomfort, etc. The system may then issue any appropriate health reminders (e.g., to take a driving break, take a restroom break, etc.,) or more urgent alerts (e.g., to pull over immediately, etc.).

In various embodiments, the system utilizes the AI model, including any AI, machine learning, and computer vision techniques to track different portions or segments of the driver such as the eyes and body of the driver 304. For example, the system my track the gaze of the driver, the head movements of the driver, and the body movements of the driver. The system may then utilize the AI model to determine particular behaviors that may be risky or dangerous. For example, slouching body and drooping head may indicate drowsiness. A driver's head being turned too often to a location away from the road ahead (e.g., toward the screen of a smartphone, etc.) may indicate distractedness from driving.

In various embodiments, the vehicle 302 is equipped with perceptions sensors positioned or located on the exterior and in the interior of the vehicle 302. The system may utilize some perceptions sensors in the interior of the vehicle 302 to view the external environment (e.g., through the windows). These perception sensors capture images of an external environment.

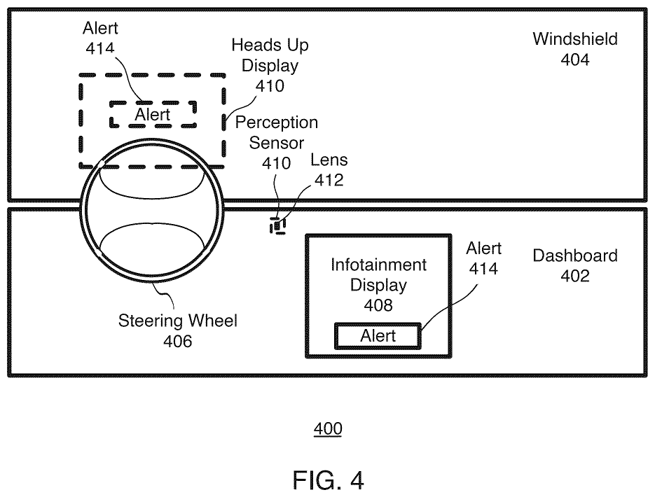

FIG. 4 is a block diagram of an environment 400, showing a view toward the front interior of a vehicle. This portion of the vehicle may be that of the vehicle 104 shown in FIG. 1 and/or the vehicle 302 shown in FIG. 3. Shown is a dashboard 402, a windshield 404, a steering wheel 406, an infotainment display 408, a heads up display 410, a perception sensor 410 and a lens 412.

In various embodiments, when the system 102 provides alerts such as the alert 414 in the infotainment display 408 and the alert 414 in the heads up display 410. As described herein in association with other embodiments, the system may provide in the alerts health reminders such as periodic reminders to take driving breaks or rest room breaks during long trips. If the system determines an elevated level urgency such as the driver falling asleep at the wheel, the system may issue an urgent alert, which may be rendered to be more visible and with a louder sound alert.

In various embodiments, the heads up display 410 provides an augmented reality (AR) windshield showing the actual physical road and augments or overlays the road seen through the windshield 404 with any instructions or directions to a safe place to pull over, the next rest stop, etc.

In various embodiments, the system 102 may verbally navigate (e.g., via speakers) or visually navigate (e.g., via visual images on the infotainment display 408 and/or the heads up display 410) the driver to a safe spot to pull over or the next rest stop or service station.

In various embodiments, in the case of autonomous vehicles or similar autonomous capabilities, the system may implement automatic safety actions, such as automatically breaking to slow down or halt the vehicle. The system may also take control of the steering of the vehicle to automatically pull over or drive through any safe spot to pullover.

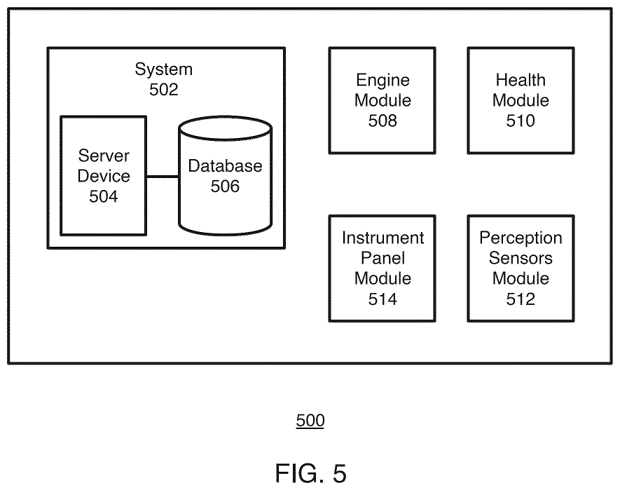

FIG. 5 is a block diagram of an example high-level architecture 500 for providing health reminders for occupants of a vehicle. Shown is a system 502, which may be used to implement the system 102 of FIG. 1. The system 502 includes a server device 504 and a database 506. Also shown is an engine module 508, a health module 510, a perception sensors module 512, and an instrument panel module 514. The engine module 508, the health module 510, the perception sensors module 512, and the instrument panel module 514 may be implemented using a combination of hardware and software. In various embodiments, the software may include and execute any suitable AI model, including any AI, machine learning, and computer vision techniques to track changes to the position of the driver, including head movements and eye movements of the driver. The system may utilize the AI model to detect any unsafe behaviors of the driver such as falling asleep, displaying health reminders and/or alerts as appropriate, thereby maximize safety for the driver and other occupants in the vehicle.

The system 502 communicates data signals and control signals with the engine module 508, the health module 510, the perception sensors module 512, and the instrument panel module 514 via the server device 504. The database 506 may be used to store various types of information such as preferred settings of the driver's seat, mirrors, and perception sensors, as well as AI training information, for example.

The system enables the engine module 508 to monitor and track the performance of various aspects of the engine (e.g., speed, steering, driving patterns if different drivers, etc.). The system also enables the health module 510 monitor and track movements and behavior of the driver (e.g., if the driver exhibits drowsiness, distractedness, etc.). The system also enables the perception sensors module 512 to control the perception sensors. The system also enables the instrument panel module 514 to control information displayed on the instrument panel and to enable the driver to interact with the infotainment display or system of the instrument panel.

Embodiments described herein have numerous benefits. For example, embodiments monitor a driver of a vehicle to ensure that the driver driving in a safe manner. Embodiments provide the driver with health alerts that may remind the driver to take driving breaks on long drives, or may alert the driver that the driver appears to be falling asleep while driving, etc.

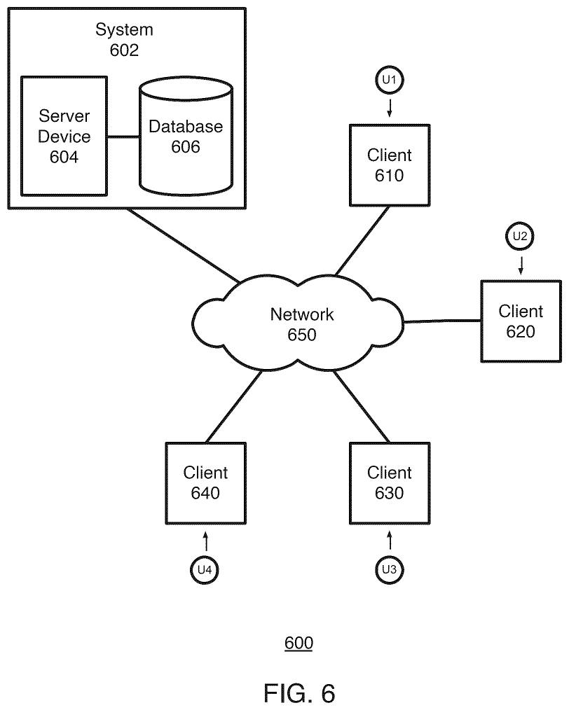

FIG. 6 is a block diagram of an example network environment 600 of the present disclosure. In some embodiments, network environment 600 includes a system 602, which includes a server device 604 and a database 606. In various embodiments, the system 602 may be used to implement the system 102 of FIG. 1, as well as to perform embodiments described herein. The network environment 600 also includes the client devices 610, 620, 630, and 640, which may communicate with the system 602 and/or may communicate with each other directly or via the system 602. The network environment 600 also includes a network 650 through which the system 602 and the client devices 610, 620, 630, and 640 communicate. The network 650 may be any suitable communication network such as a Wi-Fi network, Bluetooth network, wide area network (WAN), local area network (LAN), the Internet, etc.

For ease of illustration, FIG. 6 shows one block for each of the system 602, server device 604, and the network database 606, and shows four blocks for the client devices 610, 620, 630, and 640. The blocks 602, 604, and 606 may represent multiple systems, server devices, and network databases. Also, there may be any number of client devices. In other embodiments, the environment 600 may not have all of the components shown and/or may have other elements including other types of elements instead of, or in addition to, those shown herein.

While the server device 604 of the system 602 performs embodiments described herein, in other embodiments, any suitable component or combination of components associated with the system 602 or any suitable processor or processors associated with the system 602 may facilitate performing the embodiments described herein.

In the various embodiments described herein, a processor of the system 602 and/or a processor of any the client device 610, 620, 630, and 640 cause the elements described herein (e.g., information, etc.) to be displayed in a user interface on one or more display screens.

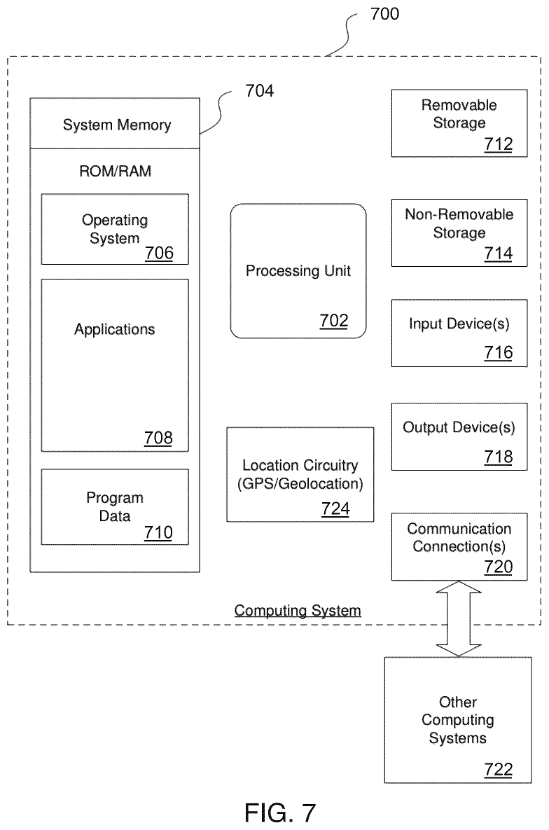

FIG. 7 is a block diagram of an example computing system 700 of the present disclosure. The computing system 700 may be used to implement the system 102 of FIG. 1 and/or the server system 602 of FIG. 6 and/or, as well as to perform embodiments described herein. The computing system 700 typically includes at least one processing unit 702 and a system memory 704. Depending on the particular configuration and type of computing device, the system memory 704 may be volatile such as random-access memory (RAM), non-volatile such as read-only memory (ROM), flash memory, and the like, or some combination of volatile memory and non-volatile memory. The system memory 704 typically maintains an operating system 706, one or more applications 708, and program data 710. The operating system 706 may include any number of operating systems executable on desktops or portable devices including, but not limited to, Linux, Microsoft Windows®, Apple OS®, or Android®.

The computing system 700 may also have additional features or functionality. For example, the computing system 700 may also include additional data storage devices (removable and/or non-removable) such as, for example, magnetic disks, optical disks, tape, or flash memory. Such additional storage may include a removable storage 712 and a non-removable storage 714. Computer storage media may include volatile and non-volatile, removable and non-removable media implemented in any method or technology for storage of information, such as computer-readable instructions, data structures, program modules or other data. The system memory 704, the removable storage 712, and the non-removable storage 714 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 700. Any such computer storage media may be part of the computing system 700.

The computing system 700 may also have input device(s) 716 such as a keyboard, mouse, pen, voice input device, touchscreen input device, etc. Output device(s) 718 such as a display, speakers, printer, short-range transceivers such as a Bluetooth transceiver, etc., may also be included. The computing system 700 also may include one or more communication connections 720 that allow the computing system 700 to communicate with other computing systems 722, such as over a wired or wireless network or via Bluetooth (a Bluetooth transceiver may be regarded as an input/output device and a communications connection). The one or more communication connections 720 are an example of communication media. Available forms of communication media typically carry computer-readable instructions, data structures, program modules or other data in a modulated data signal such as a carrier wave or other transport mechanism and include any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, radio frequency (RF), infrared and other wireless media. The term computer-readable media as used herein includes both storage media and communication media.

The computing system 700 may also include location circuitry 724. In various embodiments, the location circuitry 724 may include circuitry including global positioning system (GPS) circuitry and/or geolocation circuitry. The location circuitry 724 may automatically discern its location based on relative positions to multiple GPS satellites and/or triangulation using cellular carrier network(s) and/or IEEE Standard 802.11 wireless (Wi-Fi) networks (collectively referred to as “geolocation services”) to determine location based on multiple cellular communications facilities and/or multiple Wi-Fi networks. The location circuitry 724, including GPS circuitry and/or geolocation circuitry, is frequently incorporated in smartphones and many other tablets or other portable devices. In various embodiments, computing system 700 may not have all of the components shown and/or may have other elements including other types of components instead of, or in addition to, those shown herein.

Although the present disclosure is illustrated and described herein with reference to illustrative embodiments and specific examples provided, it will be readily apparent to those of ordinary skill in the art that other embodiments and examples may perform similar functions and/or achieve like results. All such equivalent embodiments and examples are within the spirit and scope of the present disclosure and are intended to be covered by the following non-limiting claims for all purposes.

What is claimed is:

1. A system comprising:
a plurality of perception sensors coupled to a vehicle;
one or more processors; and
logic encoded in one or more non-transitory computer-readable storage media for execution by the one or more processors and when executed operable to cause the one or more processors to perform operations comprising:
capturing data associated with a driver of the vehicle using the plurality of perception sensors;
detecting a health trigger event based on the data that is captured;
identifying one or more driver attributes associated with the health trigger event;
estimating one or more severity levels of the health trigger event based on the one or more driver attributes that are identified; and
transmitting one or more health alerts to one or more target recipients based on the one or more severity levels meeting a predetermined severity threshold.

2. The system of claim 1, wherein the one or more driver attributes comprise one or more of abnormal head movement, abnormal eye movement, and abnormal hand movement.

3. The system of claim 1, wherein at least one health alert of the one or more health alerts is transmitted to the driver of the vehicle, and wherein the at least one health alert provides one or more recommended actions for the driver of the vehicle.

4. The system of claim 1, wherein the logic when executed is further operable to cause the one or more processors to perform operations comprising:
learning one or more behavior patterns of the driver of the vehicle based on driver compliance with one or more previously recommended actions; and
performing one or more safety actions of the vehicle to avoid an accident.

5. The system of claim 1, wherein at least one service alert of the one or more service alerts is transmitted to at least one third party entity, and wherein the least one third party entity alerts other drivers of any hazardous conditions associated with driver of the vehicle.

6. The system of claim 1, wherein the logic when executed is further operable to cause the one or more processors to perform operations comprising:
identifying one or more vehicle performance attributes associated with the health trigger event; and
estimating one or more severity levels of the health trigger event based on the one or more vehicle performance attributes that are identified.

7. The system of claim 1, wherein the logic when executed is further operable to cause the one or more processors to perform operations comprising identifying one or more vehicle performance attributes associated with the health trigger event, and wherein the one or more vehicle performance attributes comprise abnormal steering.

8. A non-transitory computer-readable storage medium with program instructions stored thereon, the program instructions when executed by one or more processors are operable to cause the one or more processors to perform operations comprising:
capturing data associated with a driver of the vehicle using the plurality of perception sensors;
detecting a health trigger event based on the data that is captured;
identifying one or more driver attributes associated with the health trigger event;
estimating one or more severity levels of the health trigger event based on the one or more driver attributes that are identified; and
transmitting one or more health alerts to one or more target recipients based on the one or more severity levels meeting a predetermined severity threshold.

9. The computer-readable storage medium of claim 8, wherein the one or more driver attributes comprise one or more of abnormal head movement, abnormal eye movement, and abnormal hand movement.

10. The computer-readable storage medium of claim 8, wherein at least one health alert of the one or more health alerts is transmitted to the driver of the vehicle, and wherein the at least one health alert provides one or more recommended actions for the driver of the vehicle.

11. The computer-readable storage medium of claim 8, wherein the instructions when executed are further operable to cause the one or more processors to perform operations comprising:
learning one or more behavior patterns of the driver of the vehicle based on driver compliance with one or more previously recommended actions; and
performing one or more safety actions of the vehicle to avoid an accident.

12. The computer-readable storage medium of claim 8, wherein at least one service alert of the one or more service alerts is transmitted to at least one third party entity, and wherein the least one third party entity alerts other drivers of any hazardous conditions associated with driver of the vehicle.

13. The computer-readable storage medium of claim 8, wherein the instructions when executed are further operable to cause the one or more processors to perform operations comprising:
identifying one or more vehicle performance attributes associated with the health trigger event; and
estimating one or more severity levels of the health trigger event based on the one or more vehicle performance attributes that are identified.

14. The computer-readable storage medium of claim 8, wherein the instructions when executed are further operable to cause the one or more processors to perform operations comprising identifying one or more vehicle performance attributes associated with the health trigger event, and wherein the one or more vehicle performance attributes comprise abnormal steering.

15. A computer-implemented method for providing vehicle demos and conversations with product experts, the method comprising:
capturing data associated with a driver of the vehicle using the plurality of perception sensors;
detecting a health trigger event based on the data that is captured;
identifying one or more driver attributes associated with the health trigger event;
estimating one or more severity levels of the health trigger event based on the one or more driver attributes that are identified; and
transmitting one or more health alerts to one or more target recipients based on the one or more severity levels meeting a predetermined severity threshold.

16. The method of claim 15, wherein the one or more driver attributes comprise one or more of abnormal head movement, abnormal eye movement, and abnormal hand movement.

17. The method of claim 15, wherein at least one health alert of the one or more health alerts is transmitted to the driver of the vehicle, and wherein the at least one health alert provides one or more recommended actions for the driver of the vehicle.

18. The method of claim 15, further comprising:
learning one or more behavior patterns of the driver of the vehicle based on driver compliance with one or more previously recommended actions; and
performing one or more safety actions of the vehicle to avoid an accident.

19. The method of claim 15, wherein at least one service alert of the one or more service alerts is transmitted to at least one third party entity, and wherein the least one third party entity alerts other drivers of any hazardous conditions associated with driver of the vehicle.

20. The method of claim 15, further comprising:
identifying one or more vehicle performance attributes associated with the health trigger event; and
estimating one or more severity levels of the health trigger event based on the one or more vehicle performance attributes that are identified.
